(19) United States
(12) Patent Application Publication
(10) Pub. No.: US 2009/0291793 A1
(43) Pub. Date: Nov. 26, 2009

(54) Pulley Apparatus for Retaining an Object in a Stationary Position

(76) Inventor: Gerard Marchesseault, West Stewartstown, NH (US)

Correspondence Address: HAYES, SOLOWAY P.C., 175 CANAL STREET, MANCHESTER, NH, 03101, US

(21) Appl. No.: 12/126,472

(22) Filed: May 23, 2008

(51) Int. Cl. F16H 55/50; F16D 13/04

(52) U.S. Cl. 474/166; 464/42

(57) ABSTRACT

A system and method for retaining an object in a stationary position is provided. Generally, the system contains a pulley apparatus for retaining an object in a stationary position, the apparatus comprising a conical pulley rotateable about an axis, an exterior surface of the pulley having a convex shape, a pulley cable in communication with the exterior surface and an angular biasing mechanism applying a torquing force to the pulley.

### FIELD OF THE INVENTION

The present invention is generally related to a pulley and more particularly is related to a pulley apparatus for retaining an object in a stationary position.

### BACKGROUND OF THE INVENTION

It is well known to at least partially offset the weight of a movable object that is to be raised and lowered within a range of movement. If precisely balanced, the object remains in place when positioned, rather than tending to fall because due to gravity, or rise because of an excessive offset force. An operator or the like need only exert the force needed to move the object from one position to another, and need not offset the weight of the object itself. To avoid the need for accommodating a counterbalancing deadweight, the weight of the object is advantageously offset with a spring. Familiar examples of spring-counterbalanced weights are window sashes, garage doors, movable-panel blackboards, and supporting carriages for vertically movable equipment.

Spring force varies as a function of deflection of the spring; however, the weight of the movable object is fixed. In order to compensate for the additional force exerted by a counterbalancing spring when the spring is deflected (e.g., as a window sash is being lowered), it is known to provide a compensating pulley that converts a linearly varying spring force to a constant force. A flexible cord, cable, wire, rope or the like connects the spring and the supported weight via a conical or spiral pulley. The spiral pulley defines a radius for the cord that varies linearly with displacement of the ends of the spring, and thus defines a linearly varying moment arm to compensate for the variation in spring force over the range of movement of the object. This idea is workable for various types of springs in extension or retraction, and for various weights and other constant force exerting conditions.

Some devices in the prior art use a helical coil spring for producing force varying linearly with spring deflection, namely compression and extension of the spring along the central axis of the helix. This form of spring obviously requires a housing at least as long as the full extension length of the spring. A more compact form of spring is possible, wherein the spring is wound spirally in a plane. The inner end of the spring can be fixed, and the outer end can be rotated around the fixed inner end or pulled outwardly along a tangent. Similarly, the outer end can be fixed and the inner end arranged to rotate a shaft. The movable end of the spring is connected to rotate a conical pulley relative to the fixed end. This spiral form of spring, known as a power spring or clock spring, is relatively compact.

It is axiomatic that the force exerted by a resilient structure defining a spring in extension or compression varies linearly with the relative displacement of the ends of the spring. The same is true of torsional (twisting) displacement of the ends of a resilient object. Wherein the pulley carrying the cord is conical, a linear relationship or “spring constant” is assumed for the spring as a whole, with the spring force compensated in an amount directly proportional to displacement. However, in a power spring, the force exerted by the spring as a whole is not linear, i.e., not directly proportional to displacement. The effectiveness of known power spring balances is thus limited. Various modifications of power spring apparatus have been suggested to improve operation, but persons skilled in the art have continued to assume that a power spring should be compensated in the same manner as an extension spring.

Thus, a heretofore unaddressed need exists in the industry to address the aforementioned deficiencies and inadequacies.

### SUMMARY OF THE INVENTION

Embodiments of the present invention provide a pulley apparatus for retaining an object in a stationary position system. Briefly described, in architecture, one embodiment of the system, among others, can be implemented as follows. The pulley apparatus includes a conical pulley rotateable about an axis. An exterior surface of the conical pulley has a convex shape. A pulley cable is in communication with the exterior surface. An angular biasing mechanism applies a torquing force to the conical pulley.

The present invention can also be viewed as providing a method for retaining an object in a stationary position. In this regard, one embodiment of such a method, among others, can be broadly summarized by the following steps: raising an object connected to a pulley cable, the pulley cable attached to a conical pulley; rotating the conical pulley about an axis, the conical pulley having a convex exterior surface; and retaining the object at a raised position with an angular biasing mechanism.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is an illustration of a cross-sectional side view of a pulley apparatus, in accordance with a first exemplary embodiment of the present invention.

FIG. 2 is an illustration of a cross-sectional side view of a pulley structure of the pulley apparatus of FIG. 1, in accordance with the first exemplary embodiment of the present invention.

FIG. 3 is an illustration of a side view of a pulley structure of the pulley apparatus of FIG. 1, in accordance with the first exemplary embodiment of the present invention.

FIG. 4 is an illustration of a rear view of a pulley apparatus of FIG. 1, in accordance with the first exemplary embodiment of the present invention.

FIG. 5 is an illustration of a perspective view of the pulley apparatus of FIG. 1, in accordance with the first exemplary embodiment of the present invention.

FIG. 6 is a flowchart illustrating a method of or producing a constant force on an object with the pulley apparatus of FIG. 1, in accordance with the first exemplary embodiment of the present invention.

### DETAILED DESCRIPTION

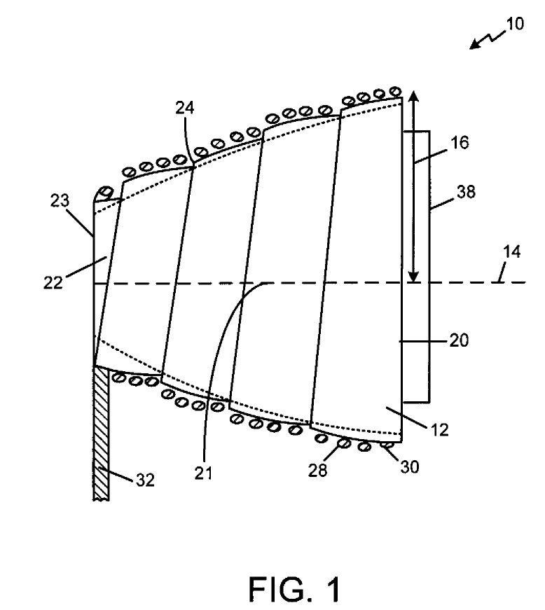

FIG. 1 is an illustration of a cross-sectional view of a pulley apparatus 10 in accordance with a first exemplary embodiment of the present invention. The pulley apparatus 10 includes a pulley structure 12 mounted to rotate about an axis 14. The pulley structure 12 has a conical shape. The conical shape is defined by a radius 16 of the pulley structure 12 that at least partially decreases in length from a rear end 20 of the pulley structure 12 to a front end 22 of the pulley structure 12. The radius 16 is measured from the axis 14 to the outermost surface of the pulley structure 12 in a direction orthogonal with the axis 14. The decrease in length of the radius 16 may be, for example, gradual or precipitous and may not be uniform, and may further be any design known to those having ordinary skill in the art capable of defining a conical shape. At the front end 22 of the pulley structure 12, the radius 16 may be substantially small thereby creating an apex in the pulley structure 12 (not shown). In accordance with the first exemplary embodiment, the front end 22 of the pulley structure 12 may also include a frustum 23, thereby creating a frusto-conical structure. FIG. 1 shows a pulley structure 12 where the front end 22 includes a frustum 23.

The pulley apparatus 10 also includes an exterior surface 24 with a convex shape. The convex shape may be defined as an outward curve seen in the profile of the pulley structure 12 with respect to a central portion 21 of the pulley structure 12. In FIG. 1, the convex shape is represented by the dotted lines approximating the profile of the pulley structure 12. The exterior surface 24 may be made of the same or a different material than the pulley structure 12.

The exterior surface 24 may be integral with the pulley structure 12. For example, the pulley structure 12 and exterior surface 24 may be machined, forged or molded out of a single material such that there is no boundary between the pulley structure 12 and the exterior surface 24. The exterior surface 24 and the pulley structure 12 may be made of different materials and bonded together. In this exemplary embodiment, there may be a boundary between the exterior surface 24 and the pulley structure, 12 but the two materials may be integral and function as one structure. Additionally, the exterior surface 24 may be detachably affixed to the pulley structure 12. The means of detachably affixing the exterior surface 24 to the pulley structure 12 may be any technique or design known to those having ordinary skill in the art capable of providing successful use of the pulley apparatus 10. Detachably affixing the exterior surface 24 may allow a single pulley structure 12 to be adapted with a plurality of exterior surfaces 24 that may have different shapes. Furthermore, this may allow a means for convenient replacement of the exterior surface 24 if there is a significant amount of wear and tear to the pulley apparatus 10.

The pulley apparatus 10 further includes a pulley cable 28 or a plurality of pulley cables 28. The pulley cable 28 is in communication with the exterior surface 24 of the pulley structure 12. A first end 30 of the pulley cable 28 may be fixed to the exterior surface 24 of the pulley apparatus 10. The first end 30 of the pulley cable 28 may be fixed directly to the pulley structure 12 (not shown). During use of the pulley apparatus 10, the pulley cable 28 may be wound on the exterior surface 24 of the pulley structure 12. The pulley cable 28 may be any material capable of providing successful use of the pulley apparatus 10, including but not limited to rope, chain, metallic wire and synthetic cable. The specific materials suitable to make a successful pulley cable 28 may be known to those having ordinary skill in the art.

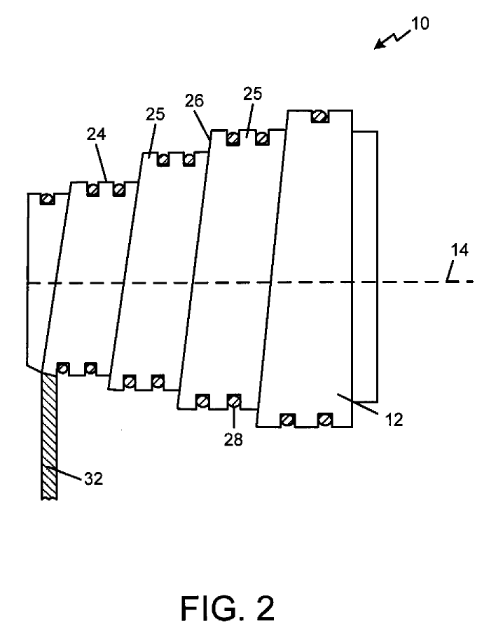

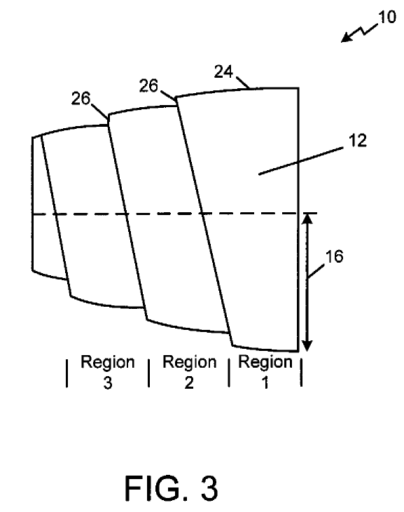

FIG. 2 is an illustration of a cross-sectional side view of a pulley structure 12 of the pulley apparatus 10 of FIG. 1, in accordance with the first exemplary embodiment of the present invention. The exterior surface 24 of the pulley structure 12 may further include at least one ridge 25. The at least one ridge 25 may be used to keep the pulley cable 28 positioned at a specified location along the exterior surface 24 of the pulley structure 12 as the pulley apparatus 10 is wound. Additionally, a plurality of ridges 25 may be included to position the pulley cable 28 with a specified range of locations along the exterior surface 24 of the pulley structure 12, the specified range being defined by the dimensions and shape of the plurality of ridges 25. For example, as shown in FIG. 2, the pulley cable 28 may be positioned in a valley created by two adjacent ridges 25. The at least one ridge may be integral with or detachably affixed to the exterior surface 24 of the pulley structure 12. The placement and design of the at least one ridge 25 may correspond to the location of a step-down 26, discussed further with regards to FIG. 3.

FIG. 3 is an illustration of a side view of the pulley structure 12 of the pulley apparatus 10 of FIG. 1, in accordance with the first exemplary embodiment of the present invention. The exterior surface 24 of the pulley structure 12 may further include at least one step-down 26. A step-down 26, which may also be considered a ‘step’ or ‘step-up’, may be defined as an abrupt change in the radius 16 of the pulley structure 12. The step-down 26 may correspond to a change in torquing force. A step-down 26 may be present between two regions of a pulley structure 12, as illustrated in FIG. 3. These regions may correspond to a change in a torquing force related to supporting the object 34. As an example, a step-down 26 may be a change in the radius 16 from a distance of 4 inches to a distance of 3.5 inches. The step-down 26 may include any design known to those having ordinary skill in the art capable of providing successful use of the pulley apparatus 10. The exterior surface 24 may include one helical step-down 26, as shown in FIG. 3. The exterior surface 24 may also include a plurality of helical or non-helical step-downs 26, the number of which may vary depending on the particular design.

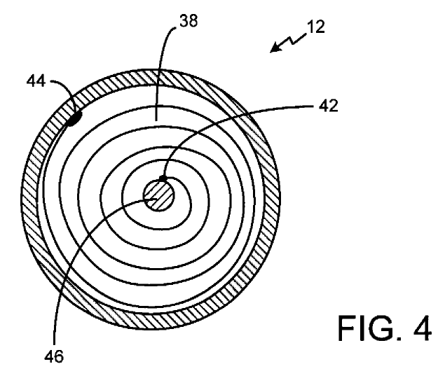

FIG. 4 is an illustration of a rear view of the pulley apparatus 10 of FIG. 1, in accordance with the first exemplary embodiment of the present invention. The pulley apparatus 10 includes an angular biasing mechanism 38 for applying a torquing force to the pulley structure 12. The angular biasing mechanism 38 may be any suitable mechanism capable of biasing the pulley structure 12. This may include, but is not limited to, a motorized device, an electrical device or a device that utilizes potential or kinetic energy. The angular biasing mechanism 38 may be situated to change a biasing force in correspondence to a rotation of the pulley. In other words, the torquing force applied to the pulley structure 12 may correspond to the rotation of the pulley structure 12 which may correspond to the movement of an object 34 attached to the pulley cable 28. The angular biasing mechanism 38 may be fully housed within the pulley structure 12 or partially housed within the pulley structure 12, as shown in FIG. 1.

An angular biasing mechanism 38 known to those having ordinary skill in the art is a spring coil. FIG. 4 illustrates a rear view of the pulley apparatus 10 with a spring coil as an angular biasing mechanism 38, which may include a proximate end 42 and a distal end 44. The proximate end 42 may be attached to a fixed point. In FIG. 4, the fixed point is illustrated as a center support shaft 46, but the fixed point may be any structure capable of providing a resistance force to the angular biasing mechanism 38, holding proximate end 42 in a substantially angularly immobile position. The distal end 44 may be attached to the pulley structure 12. The distal end 44 may be attached to any other angularly mobile structure of the pulley apparatus 10 capable of transferring a torquing force.

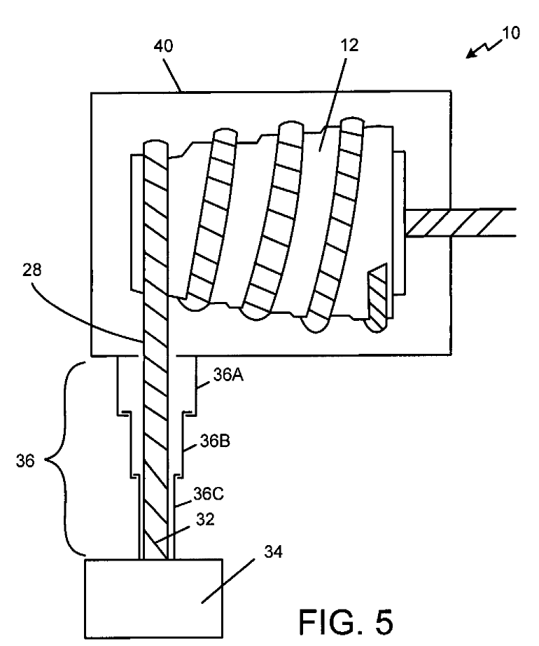

FIG. 5 is an illustration of a perspective view of a pulley apparatus 10, in accordance with the first exemplary embodiment of the present invention. The pulley apparatus 10 may include an object 34 and a recoiling shaft 36. The object 34 may be defined as any entity having a mass. The recoiling shaft 36 may be defined as a structure, or a system of structures, capable of changing length and partially supporting the object 34. For example, a recoiling shaft 36 well known to one having skill in the art is a system of metal cylinders attached together along an axis, whereby one cylinder is situated to retract and extend within a second cylinder. In accordance with the first exemplary embodiment, the recoiling shaft 36 includes a first member 36A, a second member 36B and a third member 36C. The recoiling shaft 36 may include any number of members, depending on the desired design. Additionally, the recoiling shaft 36 may be a non-ridged member such as an elastic cord.

In accordance with the first exemplary embodiment, the pulley structure 12 may be disposed within a pulley casing 40. The pulley casing 40 may be a fixed point that provides a housing structure for the pulley structure 12. The recoiling shaft 36 may be attached to the pulley casing 40 or to another fixed point. As shown in FIG. 5, the recoiling shaft 36 includes the first member 36A attached to the pulley casing 40, the second member 36B is connected to the first member 36A and a third member 36C is connected to the second member 36B. The third member 36C is attached to the object 34. The pulley cable 28 may be located within the members 36A, 36B and 36C. A second end 32 of the pulley cable 28 may be removably or permanently attached to an object 34.

With reference to FIG. 5, when the recoiling shaft 36 is fully extended, the pulley cable 28 supports substantially no weight of the object 34. Substantially all of the weight of the object 34 would be supported by first member 36A. When the recoiling shaft 36 mostly extended, but not fully extended, the pulley cable 28 supports the object 34, while first member 36A supports second member 36B and third member 36C. When the recoiling shaft 34 is recoiled, the pulley cable 28 supports the full weight of the object 34, second member 36B and third member 36C. The step-downs 26 may correlate to the weight of second and third members 36B and 36C being passed between first member 36A and the pulley cable 28.

During use of the pulley apparatus 10, the object 34 may be raised or lowered. To accomplish this, a user may exert a slight force on the object 34 in the desired direction to initiate movement of the object 34. For example, if the user desires to raise the object 34, he or she will only have to exert a slight upward force. Only a small force is needed because the user will only be lifting a small percentage of the mass of the object 34. The pulley apparatus 10 will lift the remaining mass of the object 34 by transferring the rotational force of the angular biasing mechanism 38 to the pulley structure 12, thereby changing the rotational force into a linear force within the pulley cable 28. If the recoiling shaft 36 is situated to partially support the object 34, the pulley apparatus 10 may also cause the recoiling shaft 36 to extend. The object 34 and the recoiling shaft 36 may be situated to move in correspondence to a rotation of the pulley structure 12.

When the object 34 is at the desired height, the user may let go of the object 34, leaving it in a stationary position. The object 34 will remain motionless because the force of gravity acting on the object 34 may be approximately equal to the tension of the pulley cable 28. The rotational force of the angular biasing mechanism 38 may remain continuously transferred to the pulley cable 28, securing the object 34 in the stationary position for a period of time. The rotational force needed may vary in relation to the mass of the object 34 and the shape and dimensions of the pulley structure 12. In general, the movement of the recoiling shaft 36 and the object 34 may be substantially in the vertical direction, due to the forces of gravity. However, one having ordinary skill in the art will recognize that movement of the recoiling shaft 36 and the object 34 may occur in a direction other than a substantially vertical direction, subject to the chosen design and implementation.

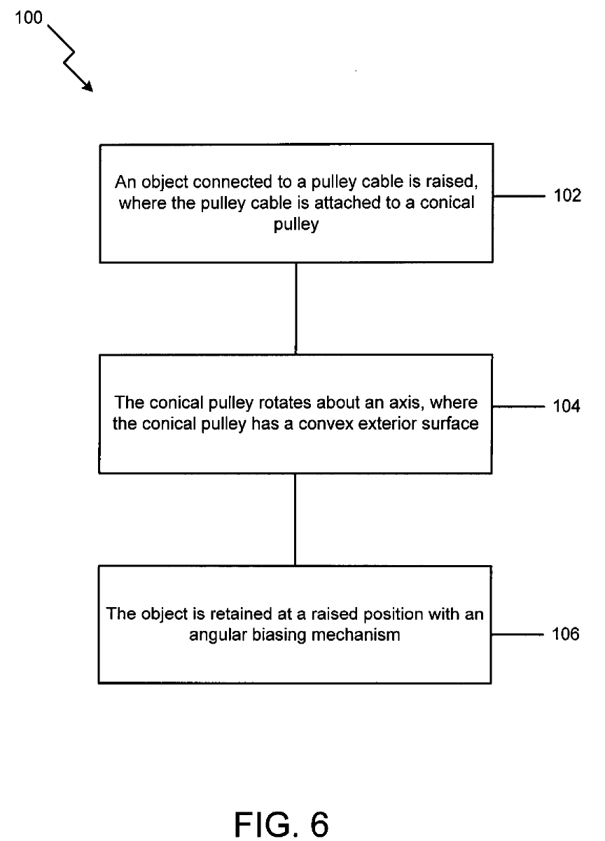

FIG. 6 is a flowchart 100 illustrating a method of producing a constant force on an object providing the abovementioned pulley apparatus 10, in accordance with the first exemplary embodiment of the invention. It should be noted that any process descriptions or blocks in flow charts should be understood as representing modules, segments, portions of code, or steps that include one or more instructions for implementing specific logical functions in the process, and alternate implementations are included within the scope of the present invention in which functions may be executed out of order from that shown or discussed, including substantially concurrently or in reverse order, depending on the functionality involved, as would be understood by those reasonably skilled in the art of the present invention.

As is shown by block 102, an object 34 connected to a pulley cable 28 is raised, where the pulley cable 28 is attached to a conical pulley 12. The conical pulley 12 rotates about an axis 14, where the conical pulley 12 has a convex exterior surface 24 (block 104). The object 34 is retained at a raised position with an angular biasing mechanism 38 (block 106).

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A pulley apparatus for retaining an object in a stationary position, the apparatus comprising:
a conical pulley rotateable about an axis;
an exterior surface of the pulley, the exterior surface having a convex shape;
a pulley cable in communication with the exterior surface; and
an angular biasing mechanism applying a torquing force to the pulley.

2. The pulley apparatus of claim 1, further comprising at least one step-down in the exterior surface.

3. The pulley apparatus of claim 1, further comprising a recoiling shaft attached to the pulley cable.

4. The pulley apparatus of claim 2, further comprising an object situated between the pulley cable and the recoiling shaft.

5. The pulley apparatus of claim 1, wherein the conical pulley further comprises a frusto-conical shape.

6. The pulley apparatus of claim 1, where the exterior surface of the pulley is integral with the pulley structure.

7. The pulley apparatus of claim 1, where the exterior surface of the pulley is detachably affixed to the pulley.

8. The pulley apparatus of claim 2, where in the at least one step-down in the exterior surface corresponds with the movement of a recoiling shaft wherein the at least one step-down corresponds to a change in a radius of the pulley.

9. The pulley apparatus of claim 1, further comprising a plurality of pulley cables in communication with the at least one step-down.

10. The pulley apparatus of claim 1, wherein one end of the pulley cable is fixed to the pulley.

11. The pulley apparatus of claim 1, wherein one end of the pulley cable is fixed to the exterior surface of the pulley.

12. The pulley apparatus of claim 2, wherein one end of the pulley cable is fixed to the recoiling shaft.

13. The pulley apparatus of claim 3, wherein one end of the pulley cable is fixed to the object.

14. The pulley apparatus of claim 1, wherein the biasing mechanism is at least partially housed within the pulley.

15. The pulley apparatus of claim 1, wherein the biasing mechanism is at least one spring coil in communication with the pulley, situated to change a biasing force in correspondence to a rotation of the pulley.

16. The pulley apparatus of claim 15, wherein the spring coil includes a proximate end and a distal end, whereby the proximate end is attached to a fixed point.

17. The pulley apparatus of claim 15, wherein the spring coil includes a proximate end and a distal end, whereby the distal end is attached to the pulley.

18. The pulley apparatus of claim 2, wherein the recoiling shaft is situated to recoil in correspondence to a rotation of the pulley.

19. The pulley apparatus of claim 2, wherein the recoiling shaft has at least one shaft member.

20. The pulley apparatus of claim 2, wherein the recoiling shaft at least partially supports an object.

21. The pulley apparatus of claim 2, wherein a proximate end of the recoiling shaft is attached to a fixed point.

22. The pulley apparatus of claim 2, wherein a distal end of the recoiling shaft is attached to the object.

23. The pulley apparatus of claim 3, wherein the object is detachably affixed to the pulley cable.

24. The pulley apparatus of claim 3, wherein the object is situated to be moved in a substantially vertical direction in correspondence to a rotation of the pulley.

25. A method of using a pulley apparatus for retaining an object in a stationary position, the method comprising the steps of:
raising an object connected to a pulley cable, the pulley cable attached to a conical pulley;
rotating the conical pulley about an axis, the conical pulley having a convex exterior surface; and
retaining the object at a raised position with an angular biasing mechanism.

26. The pulley apparatus of claim 1, further comprising at least one ridge in the exterior surface.
